(19) United States
(12) Patent Application Publication
(10) Pub. No.: US 2013/0209718 A1
(43) Pub. Date: Aug. 15, 2013

(54) Antimicrobial and Antibacterial Device Protection System

(71) Applicant: Ko-Kang Wen, Waltham, MA (US)

(72) Inventor: Ko-Kang Wen, Waltham, MA (US)

(21) Appl. No.: 13/766,354

(22) Filed: Feb. 13, 2013

Related U.S. Application Data
(60) Provisional application No. 61/598,228, filed on Feb. 13, 2012.

(51) Int. Cl. C09J 7/02

(52) U.S. Cl. CPC C09J 7/0225
USPC 428/40.2; 428/41.8; 428/41.3

(57) ABSTRACT

A protective touch screen guard for a hand held electronic device having a front face with a touch screen portion. The protective touch screen guard has a flat transparent displaying section having a front and back side. The displaying section is the same size as the front face of the electronic device and can be pressed to operate the touch screen features of the device. An adhesive is positioned on the back side of the displaying section to hold the screen onto the front fact of the device without leaving adhesive residue. A release film is positioned over the adhesive to protect the adhesive surface before adhering the screen onto the front face of the electronic device.

### CROSS REFERENCE TO RELATED APPLICATION

This application claims the benefit of and takes priority from U.S. App. No. 61/598,228, filed on Feb. 13, 2012, the contents of which are hereby incorporated by reference.

### FIELD OF THE INVENTION

The present invention relates to a touch screen film to protect the touch screen surface of hand held electronic devices that can easily be removed from the touch screen surface without leaving an adhesive residue on the electronic device and prevents bacteria from growing on the surface of the electronic device.

### BACKGROUND OF THE INVENTION

A variety of screen protector systems are known and may include protectors that provide protection for hand held, desk top and the like electronic devices having a front face that includes a touch screen portion and an outer perimeter.

The known screen protectors that use an adhesive film to create contact with the touch screen surface of the electronic device leave behind an undesirable adhesive residue that can permanently affect the surface of the touch screen surface. These screen protectors are also difficult to apply and leave behind air bubbles between the surface of the touch screen and the screen protector. Other known screen protectors do not create adhere only to the outer perimeter of the electronic device. These types of screen protectors do not allow for direct contact between the screen protector and the touch screen device that may impair user functions.

There is a need in the art for a screen protector that can have direct contact with the touch screen surface without leaving an adhesive residue and which prevents bacteria from growing on the surface of the electronic device. There is also a need in the art for a screen protector that is strong enough to prevent scratches and glare on the touch screen surface while still being easy to apply.

### SUMMARY OF THE INVENTION

It is therefore an object of this device to provide a screen protector that does not leave behind adhesive residue while maintaining direct contact with the touch screen surface of an electronic device. It is a further object of this device to provide a screen protector that decreases the growth of bacteria on the surface of the electronic device. It is a further object of this device to provide a screen protector that enhances the scent of the device attached thereto by provided a built scent emanation system.

The subject device results from the realization that the problems of bacterial growth on electronic devices and adhesive residue on the touch screen surface are addressed in a screen protective film with a layer of micro-particles providing antimicrobial treatment and an adhesive on the back of a transparent displaying section sticking to the touch screen surface of an electronic device.

The device features the screen protective film comprising a flat transparent displaying section having a back and a front side, the displaying section corresponding to the size of the front face of the electronic device. The displaying section can be pressed for operation of the touch screen portion of the electronic device. On the back side of the displaying section is an adhesive disposed to adhere to the front face of the touch screen section without leaving an adhesive residue on the screen. A release film is positioned over the adhesive for protection prior to a user adhering the protective screen onto the touch screen surface of the electronic device.

There has thus been outlined, rather broadly, the more important features of the embodiments in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

To the accomplishment of the foregoing and related ends, certain illustrative aspects are described herein and these aspects are indicative of the various ways in which the principles disclosed herein can be practiced and all aspects and equivalents thereof are intended to be within the scope of the claimed subject matter.

### DETAILED DESCRIPTION OF THE INVENTION

The detailed description set forth below is intended as a description of presently preferred embodiments of the invention and does not represent the only forms in which the present invention may be construed and/or utilized. The description sets forth the functions and the sequence of the steps for producing the invention. However, it is to be understood that the same or equivalent functions and sequences may be accomplished by different embodiments also intended to be encompassed within the scope of the invention.

The unique characteristic of the present invention is the ability to protect a touch screen surface of an electronic device by adhesive without leaving residue on the screen and while providing an antimicrobial treatment to the surface of the screen.

The present invention includes a flat transparent displaying section having a back and a front side. The displaying section can be pressed to operate the touch screen surface of the electronic device. Adhesives may be placed on the back side of the displaying section to adhere to the front face of the electronic device. Prior to using the protective screen a release film covers the adhesive. The protective screen guard has a strengthening layer shielding the electronic device from scratches and cracks. A plurality of alignment holes exists on the protective screen to allow for easier mounting onto the electronic device. A plurality of micro-particles exists on the protective screen to create anti-glare effect.

In a one embodiment the adhesive is silicone based and the strengthening layer is a PET hard coat treated surface. The release film preferably ranges from a thickness of forty-eight to fifty-two micrometers and the flat transparent displaying screen preferably ranges from a thickness of one hundred and eighteen to one hundred and thirty micrometers.

In another embodiment, the protective screen may include a plurality of scent dots which may create a scent on top of the electronic device. In another embodiment the protective screen includes a micro-particle layer on the transparent displaying section providing antimicrobial treatment.

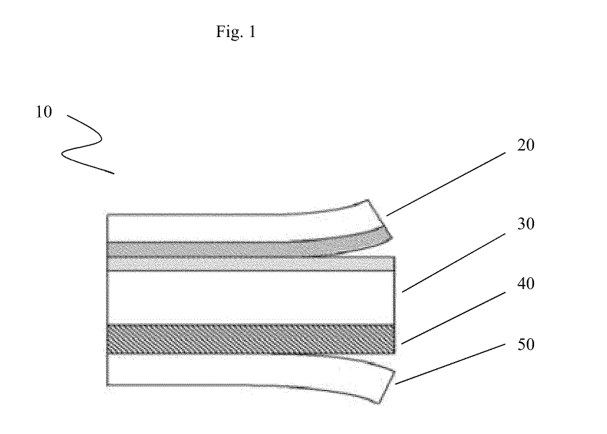

As illustrated in FIG. 1, a layering affect may be utilized wherein either the antimicrobial or the scented agents embodiments are only applied to a surface layer. In an additional embodiment, the antimicrobial or the scented agents may be permanently embedded throughout the entirety of the material.

Thus, in one embodiment, the antimicrobial coatings of the instant system may provide an advanced antimicrobial technology, designed to resist the growth of destructive microbes on the coated surfaces and antimicrobial additives that can be incorporated into many coating formulations and end products, such as:
Water-based antimicrobial coatings: indoor and outdoor acrylic paint
Solvent-based coatings: PU flooring
Powder coatings: refrigerator lining
UV-cured coatings: plastic coatings
Coil coatings: cleanroom paneling, roofing, air conditioning ducting

In creating an antimicrobial material, layer or environment, differing agents may be utilized. On these is silver, a naturally occurring and highly effective antimicrobial agent. Silver has long been known for its antimicrobial properties. Thus, silver embedded materials may be actuated at the surface of a product through the controlled release of silver ions which attack microbes and inhibit their growth in three different ways. Additionally, use of silver and copper ion systems to deliver effective and permanent protection from microbes with no risk to humans or impact on the environment may be implemented.

Further, in one method, silver and copper ions in the exchange with sodium ions found in moisture from the environment, causing a controlled release of silver and copper on demand. Inorganic Silver, in the form of silver ions, is the active ingredient in products that utilize antimicrobial technology. Silver antimicrobial technology is safe, natural and sustainable. Silver has been used for centuries for its abilities to aid preservation, for example, the ancient Greeks used silver vessels to keep their water fresh and Chinese Emperors ate with silver chopsticks. Prior to the introduction of antibiotics, silver was widely used in hospitals to combat bacteria and today it is used in a wide range of medical products, such as wound dressings and catheters, which have been shown to reduce rates of HCAI. Recent advances in antimicrobial technology allow silver to be added to everyday products at the manufacturing stage. Silver is an ideal antimicrobial agent due to its efficacy or effectiveness against a comprehensive range of microorganisms and its lack of toxicity to non-target cells. Silver antimicrobial technology can be applied to a variety of materials and, therefore, products, without affecting the performance or aesthetics in any way, other than imparting antimicrobial qualities.

In one antibacterial/microbial embodiment, the following characteristics may be present:
High transmittance with Anti-Glare and antimicrobial function;
Silicon base adhesion with static clinging function;
Easy to apply and bubble-free and reusable with no residue gum after removal;
Good performance in adhesion, flexibility and durability, low discoloration;
3H hard coat treated surface can protect screen from all kinds of scratching and damaging;
Good performance in anti-scratch and anti-smudge; and,
The ensuing product will receive approval by AATCC 147 test method, and effectively in inhibiting Staphylococcus aureus.

Further, as discussed, the antimicrobial or antibacterial features may be built into the product during the manufacturing process and becomes an intrinsic part of the product inside and at the surface, as mentioned earlier. When microbes, such as bacteria, mold and mildew that can cause stains, odors, product deterioration or transfer of germs come in contact with the product surface, the protection afforded penetrates the cell wall of the microbe and disrupts key cell functions so that the microbe cannot function, grow or reproduce.

In one embodiment, as illustrated in FIG. 1, an antibacterial device 10 may comprise an outer layer of PET protective film 20 an AG PET film 30 a silicon adhesive 40 and a PET liner 50.

In an additional embodiment to the mobile devices screen coating protector, embodiment may exist wherein the anti-microbial feature is embedded or built into the overall system or casing therefore. In such a manner material cases, protectors, and techno appliances such as anti-cellphone/mobile devices, including embedded system and wireless networks may be effectuated.

Thus, the protection may begin to work as soon as the microorganism comes into contact with the product surface and then will work continuously to maintain a consistently lower bio-burden. Thus, when the protection is built-in during the manufacturing process and will not wash off or wear away and can be engineered to provide continuous antimicrobial product protection for the useful lifetime of the product, keeping the devices cleaner and fresher.

Along these lines, such technologies as can safely & effectively inhibit or destroy the growth of harmful bacteria, viruses, mold, mildew, & fungi. Antimicrobial fibers can be blended into almost any fabric or polymer from cotton to nylon or plastic PVC to ABS, without changing their characteristics. Some of the characteristics of such a design include antimicrobial performance, uv-protection, abrasion resistance, superior colorfastness, color matching, fire retardancy, water repellency, filtration, odor reduction and ensured cleanliness.

In another embodiment illustrated is a antimicrobial system computation device comprising at least one internally disposed electronics array; at least one internally disposed control processing unit; at least one externally disposed encasement compartment comprising: a data input device; a series of input/output ports; a containment cavity. The internally disposed electronics array and the internally disposed control processing unit may be stored within the containment cavity and disposed to be contactable by the user and the externally disposed encasement compartment may also comprise an antimicrobial protection to the fingers of a user.

The externally disposed encasement compartment may also comprises a surface layer of antimicrobial material and may also comprise an entire composition of antimicrobial material. The antimicrobial system computation device may be selected from the group consisting of a cellular phone, a desk top computer, a flat screen television, a laptop computer, a conventional laptop, a dual screen laptop, an iPad, an iPhone, an iPod, an iTouch, a book reader apparatus, a computer diagnostic tool device, desk top devices, arm rest devices, a Kindle, and a Kindle Fire.

In an exemplary embodiment, An antimicrobial laptop device may be introduced and this device may comprise at least one first body component for an interface; at least one second body component for a display; at least one third body component; and a swiveled on the axis joint device third body component in flexible communication with the first body component and second body component so that these three body components opened in a Y-shaped fashion, and wherein two body components can be used as stands for the second body component provided with the display, wherein all body components comprise antimicrobial materials. Also, all body components of the antimicrobial laptop device may comprise surface layer antimicrobial materials or may also comprise antimicrobial materials throughout the entirety of the body components.

In an another embodiment, an antimicrobial apparatus for the diagnosis of the peripherals of both laptop and desktop computers may be revealed and this device may comprise a main control panel composed of antimicrobial materials; a series of auxiliary modules composed of antimicrobial materials in electrical communication. The series of auxiliary modules may comprise a module for testing a desktop PC's power supply; a module for testing a laptop PC's power supply; a module for testing a mass storage device; a module for testing cable continuity; a module for testing a desktop PC's POST function, RAM function, and video function; a module for testing a laptop PC's POST function and RAM function; and a module for testing a laptop PC's video function.

The main control panel and the series of auxiliary modules may comprise a surface layer antimicrobial material and may comprise antimicrobial materials throughout the entirety of the modules.

In an ancillary embodiment, antimicrobial cellular phone comprising a mirror surface provided on an outer case thereof over a surface region excluding a zone where pushbuttons are provided, is introduced and the mirror surface may be formed on the same side as the surface region having the pushbuttons is present or on the side opposite to that where the surface region having the pushbuttons is present. And, the outer case may be of the fold-up type, and the mirror surface may be formed on one inner surface region that is lapped over the other inner surface region when the outer case is folded up. Finally, the mirror surface may be formed by applying a coating over a base film, and the coated base film may be bonded to a surface region of the outer case.

What is claimed:

1. A protective touch screen guard for a hand held electronic device having a front face, further comprising a touch screen portion, the protective touch screen guard comprising:
a flat transparent displaying section corresponding in size to the front face of the electronic device, wherein the transparent displaying section can be pressed for operation of the touch screen portion of the electronic device;
an adhesive positioned on a back of the transparent displaying section disposed to adhere to the electronic device without leaving an adhesive residue on the electronic device; and
a release film positioned over the adhesive disposed to protect the adhesive surface prior to use of the protective screen guard.

2. The protective screen guard of claim 1, wherein the protective screen guard further comprises a strengthening layer disposed to shield the electronic device.

3. The protective screen guard of claim 1, wherein the protective screen guard further comprises a plurality of alignment holes corresponding to a plurality of user functions of the electronic device.

4. The protective screen guard of claim 1, wherein the protective screen guard further comprises a plurality of micro-particles disposed to provide anti-glare effects to the front face of the electronic device.

5. The protective screen guard of claim 1, wherein the adhesive is silicon based comprises a static cling function.

6. The protective screen guard of claim 2, wherein the strengthening layer is a PET hard coat treated surface.

7. The protective screen guard of claim 1, wherein the release film comprises a thickness from a range of forty-eight to fifty-two micrometers.

8. The protective screen guard of claim 1, wherein the flat transparent displaying screen comprises a thickness from a range of one hundred and eighteen micrometers to one hundred and thirty micrometers.

9. A protective touch screen guard for a hand held electronic device having a front face, further comprising a touch screen portion, the protective touch screen guard comprising:
a flat transparent displaying section corresponding in size to the front face of the electronic device, wherein the transparent displaying section can be pressed for operation of the touch screen portion of the electronic device;
an adhesive positioned on a back of the transparent displaying section disposed to adhere to the electronic device without leaving an adhesive residue on the electronic device;
a release film positioned over the adhesive disposed to protect the adhesive surface prior to use of the protective screen guard; and
a plurality of scent dots positioned within the flat transparent displaying section.

10. The protective screen guard of claim 9, wherein the protective screen guard further comprises a strengthening layer disposed to shield the electronic device.

11. The protective screen guard of claim 9, wherein the protective screen guard further comprises a plurality of alignment holes corresponding to a plurality of user functions of the electronic device.

12. The protective screen guard of claim 9, wherein the protective screen guard further comprises a plurality of micro-particles disposed to provide anti-glare effects to the front face of the electronic device.

13. The protective screen guard of claim 9, wherein the adhesive is silicon based comprises a static cling function.

14. The protective screen guard of claim 10, wherein the strengthening layer is a PET hard coat treated surface.

15. A protective touch screen guard for a hand held electronic device having a front face, further comprising a touch screen portion, the protective touch screen guard comprising:
a flat transparent displaying section corresponding in size to the front face of the electronic device, wherein the transparent displaying section can be pressed for operation of the touch screen portion of the electronic device;
an adhesive positioned on a back of the transparent displaying section disposed to adhere to the electronic device without leaving an adhesive residue on the electronic device;
a release film positioned over the adhesive disposed to protect the adhesive surface prior to use of the protective screen guard; and
a micro-particle layer on the flat transparent displaying section disposed to provide antimicrobial treatment.

16. The protective screen guard of claim 15, wherein the protective screen guard further comprises a strengthening layer disposed to shield the electronic device.

17. The protective screen guard of claim 15, wherein the protective screen guard further comprises a plurality of alignment holes corresponding to a plurality of user functions of the electronic device.

18. The protective screen guard of claim 15, wherein the protective screen guard further comprises a plurality of micro-particles disposed to provide anti-glare effects to the front face of the electronic device.

19. The protective screen guard of claim 15, wherein the adhesive is silicon and comprises a static cling function.

20. The protective screen guard of claim 16, wherein the strengthening layer is a PET hard coat treated surface.
